(19) United States
(12) Patent Application Publication
(10) Pub. No.: US 2017/0149859 A1
(43) Pub. Date: May 25, 2017

(54) METHOD, DEVICE AND SYSTEM FOR PLAYING NETWORK VIDEOS

(71) Applicants: LE HOLDINGS (BEIJING) CO., LTD., BEIJING (CN); LECLOUD COMPUTING CO., LTD., BEIJING (CN)

(72) Inventor: Jinfu CHEN, Beijing (CN)

(73) Assignees: LE HOLDINGS (BEIJING) CO., LTD., BEIJING (CN); LECLOUD COMPUTING CO., LTD., BEIJING (CN)

(21) Appl. No.: 15/245,103

(22) Filed: Aug. 23, 2016

Related U.S. Application Data
(63) Continuation of application No. PCT/CN2016/083053, filed on May 23, 2016.

(30) Foreign Application Priority Data
Nov. 20, 2015 (CN) 201510811582.6

(51) Int. Cl. H04L 29/06; H04L 12/46; G06F 17/30; H04L 29/08

(52) U.S. Cl. CPC H04L 65/605; H04L 67/1076; H04L 67/2842; H04L 12/4633; G06F 17/30867; G06F 17/30817; G06F 17/3048; H04L 67/02

(57) ABSTRACT

The embodiments of the present invention provide a method, a device and a system for playing network videos, wherein the method includes: querying, by a first download node, whether a slicing data of a network video requested for playing and satisfying playing conditions exists in a pre-established download cache memory according to a video playing request of a browser; if no, downloading the video data of the network video from a network video server, slicing the video data into a plurality of slicing data, storing the slicing data in the download cache memory, and notifying a P2P server that the slicing data in a current download cache memory for downloading is provided; if yes, querying a second download node having other slicing data from the P2P server, downloading the other slicing data from the second download node, storing the other slicing data in the download cache memory, and notifying the P2P server that the slicing data in the current download cache memory for downloading is provided; and merging and encapsulating the slicing data in the download cache memory into video data and providing the video data to the browser. The embodiments of the present invention save the bandwidth resources.

### CROSS-REFERENCE

This application is based upon Chinese Patent Application 201510811582.6, titled “Method, Device and System for Playing Network Videos,” filed Nov. 20, 2015, the entire contents of which are incorporated herein by reference.

### TECHNICAL FIELD

The embodiments of the present invention relate to the field of video technologies, and more particularly, to a method, device and system for playing network videos.

### BACKGROUND

A network video refers to a sound image file which is provided by a network video service provider, in a play format of streaming media, and may implement online live or on-demand playing. The network video may be played by using various terminals through a browser.

Moreover, with the appearance of HTML(hypertext markup language) 5 technology, the browser may support such multimedia functions like audio, video, etc. Therefore, a browser based on HTML5 may directly play the network video, i.e., directly download and play the video of the network video from a network video server.

However, in the prior art, because the browser based on HTML5 directly downloads and plays the video data from the network video server, more video bandwidth resources are occupied.

### SUMMARY

The embodiments of the present invention provide a method, a device and a system for playing network videos, for solving the technical problem in the prior art more bandwidth resources are occupied by playing network videos via a browser.

A first aspect of the embodiments of the present invention provides a method for playing network videos, including:

querying, by a first download node, whether a slicing data of a network video requested for playing and satisfying playing conditions exists in a pre-established download cache memory according to a video playing request of a browser, wherein the video address of the browser is preset as the address of the download cache memory;

if no, downloading the video data of the network video from a network video server, slicing the video data into a plurality of slicing data, storing the slicing data in the download cache memory, and notifying a P2P server that the slicing data in the current download cache memory for downloading could be provided; and

if yes, querying a second download node having other slicing data excluding the slicing data in the download cache memory from the P2P server, downloading the other slicing data excluding the slicing data in the download cache memory from the second download node, storing the other slicing data in the download cache memory, and notifying the P2P server that the slicing data in the current download cache memory for downloading could be provided; and

merging and encapsulating the slicing data in the download cache memory into video data and providing the video data to the browser so that the browser acquires and plays the video data.

A second aspect of the embodiments of the present invention provides a method for playing network videos, including:

receiving, by a browser, a video playing request;

invoking a first download node to query whether a slicing data of a network video requested for playing and satisfying playing conditions exists in a pre-established download cache memory according to the video playing request; if no, downloading the video data of the network video from a network video server, slicing the video data into a plurality of slicing data, storing the slicing data in the download cache memory, and notifying a P2P server that the slicing data in the current download cache memory for downloading could be provided; and if yes, querying a second download node having other slicing data excluding the slicing data in the download cache memory from the P2P server, downloading the other slicing data excluding the slicing data in the download cache memory from the second download node, storing the other slicing data in the download cache memory, and notifying the P2P server that the slicing data in the current download cache memory for downloading could be provided; and

acquiring the video data merged and encapsulated from the slicing data in the download cache memory by the first download node from the download cache memory and playing the video data.

A third aspect of the embodiments of the present invention provides a device for playing network videos, including:

a detection module detection module configured to query whether a slicing data of a network video requested for playing and satisfying playing conditions exists in a pre-established download cache memory according to a video playing request of a browser, wherein the video address of the browser is preset as the address of the download cache memory;

a first download module configured to, when the detection result of the detection module is no, download the video data of the network video from the network video server, slice the video data into a plurality of slicing data, store the slicing data in the download cache memory, and notify a P2P server that the slicing data in the current download cache memory for downloading could be provided;

a second download module configured to, if the detection result of the detection module is yes, query a second download node having other slicing data excluding the slicing data in the download cache memory from the P2P server, download the other slicing data excluding the slicing data in the download cache memory from the second download node, store the other slicing data in the download cache memory, and notify the P2P server that the slicing data in the current download cache memory for downloading could be provided; and

an encapsulation module configured to merge and encapsulate the slicing data in the download cache memory into video data and providing the video data to the browser so that the browser acquires and plays the video data.

A fourth aspect of the embodiments of the present invention provides a device for playing network videos, including:

a request receiving module configured to receive a video playing request;

an invoking module configured to invoke a first download node to query whether a slicing data of a network video requested for playing and satisfying playing conditions exists in a pre-established download cache memory according to the video playing request; if no, download the video data of the network video from a network video server, slice the video data into a plurality of slicing data, store the slicing data in the download cache memory, and notify a P2P server that the slicing data in the current download cache memory for downloading could be provided; and if yes, query a second download node having other slicing data excluding the slicing data in the download cache memory from the P2P server, download the other slicing data excluding the slicing data in the download cache memory from the second download node, store the other slicing data in the download cache memory, and notify the P2P server that the slicing data in the current download cache memory for downloading could be provided; and

a playing module configured to acquire the video data merged and encapsulated from the slicing data in the download cache memory by the first download node from the download cache memory and playing the data.

A fifth aspect of the embodiments of the present invention provides a system for playing network videos, including:

a browser, a download node and a download cache memory, wherein:

the download cache memory is pre-established by the download node;

the download node is configured with the device for playing network videos provided by the third aspect above; and

the browser is configured with the device for playing network videos provided by the fourth aspect above.

According to the method, device and system for playing network videos provided by the embodiments of the present invention, the browser downloads the video data of the network video through the first download node, the first download node downloads the video data of the network video from the network video server, slices the video data into a plurality of slicing data, and stores the video data in the download cache memory; and queries the second download node having other slicing data through the P2P server when the slicing data satisfying the playing conditions exist in the download cache memory, and downloads other slicing data from the second download node, rather than continuously downloads the video data of the network video from the network video server, so that the bandwidth occupied by downloading the network video may be reduced, and the bandwidth resources may be saved.

### BRIEF DESCRIPTION OF THE DRAWINGS

In order to explain the technical solutions in the embodiments of the present invention or in the prior art more clearly, the drawings used in the descriptions of the embodiments or the prior art will be simply introduced hereinafter. It is apparent that the drawings described hereinafter are merely some embodiments of the present invention, and those skilled in the art may also obtain other drawings according to these drawings without going through creative work.

The drawings illustrated herein are intended to provide further understanding of the present invention, constituting a part of the present application. Exemplary embodiments and explanations of the present invention here are only for explanation of the present invention, but are not intended to limit the present invention. In the drawings:

FIG. 1 is a flow chart of a method for playing network videos according to the present invention according to one embodiment;

FIG. 2 is a flow chart of the method for playing network videos according to the present invention according to another embodiment;

FIG. 3 is a structure diagram of a device for playing network videos according to the present invention according to one embodiment;

FIG. 4 is a structure diagram of the device for playing network videos according to the present invention according to another embodiment;

FIG. 5 is a structural diagram of a device for playing network videos according to another embodiment;

FIG. 6 is a structural diagram of a device for playing network videos according to another embodiment.

### DETAILED DESCRIPTION

To make the objects, technical solutions and advantages of the embodiments of the present invention more clearly, the technical solutions of the present invention will be clearly and completely described hereinafter with reference to the embodiments and drawings of the present invention. Apparently, the embodiments described are merely partial embodiments of the present invention, rather than all embodiments. Other embodiments derived by those having ordinary skills in the art on the basis of the embodiments of the present invention without going through creative efforts shall all fall within the protection scope of the present invention.

The technical solution of the embodiment of the present invention is mainly applied to an application scenario that plays a network video through a browser, wherein the browser is an HTML5 browser, the HTML5 browser may support such multimedia functions as audio, video, or the like, and can directly download and play the video data of the network video. However, more video bandwidth resources will be occupied by directly downloading and playing the video data through the browser, which will affect the playing efficiency to some degree.

In order to solve this technical problem, it is found by the inventor upon a series of studies that if the P2P (peer-to-peer) technology may be applied to the video playing via the browser, then the bandwidth resources occupied by downloading the videos may be reduced through resource sharing. However, the browser completely downloads and parses the video data by itself, which is not controlled by developers totally, and is not beneficial for implementing the sharing and downloading of medium resources in the browser.

Therefore, in order to reduce the video bandwidth resources occupied by downloading the video data, it is creatively proposed by the inventor that a download node may be set in a terminal in a browser application, wherein the download node is a program in the terminal that can be invoked by the browser. In the embodiment of the present invention, when the browser receives a video playing request, then the terminal will invoke the first download node to query whether a slicing data of the network video requested for playing and satisfying playing conditions exists in a pre-established download cache memory according to the video playing request; if no, the terminal downloads the video data from the network video server, then slices the video data into slicing data, and notifies a P2P server that the slicing data for downloading could be provided, so that the slicing data may be downloaded by other download nodes; and if yes, then it does not need to continuously download the network video from the network video server; instead, a second download node having other slicing data of the network video may be queried from the P2P server, and the other slicing data may be acquired from the second download node; while the slicing data in the download cache memory after being merged and encapsulated into video data, may be provided to the browser to play. Through the technical solution of the embodiment of the present invention, the video data may be acquired through the P2P technology, so that it does not need to download the data from the network video server all the time, which facilitates resource sharing and saves the bandwidth resources occupied by downloading the video.

The technical solutions of the present invention will be described in details hereinafter with reference to the drawings.

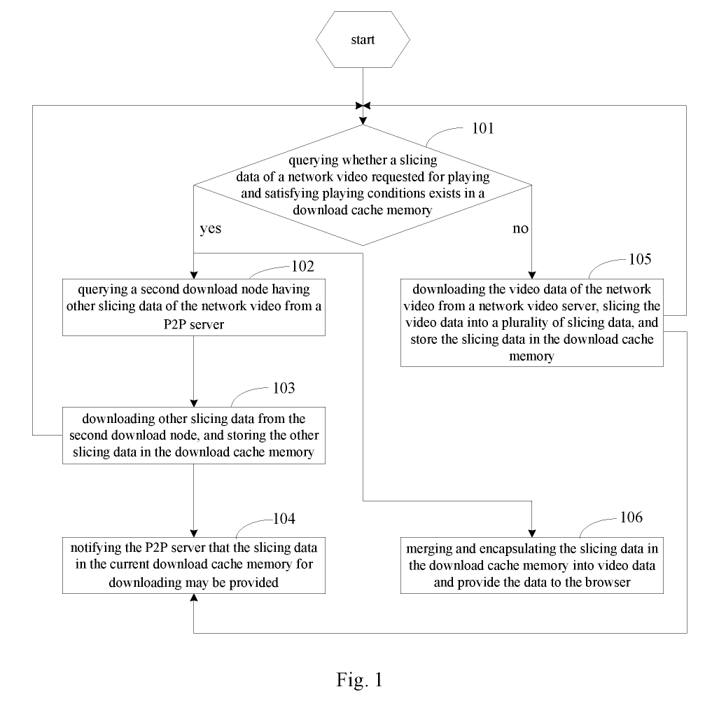

FIG. 1 is a flow chart of one embodiment of a method for playing network videos provided by the present invention. A browser of the embodiment of the present invention is a browser based on HTML5 which supports such multimedia functions as audio, video, or the like. The browser may be installed in various terminals, for example, a computer, a mobile phone, a tablet.

The method may include the several steps as follows.

In step 101: a first download node queries whether a slicing data of a network video requested for playing and satisfying playing conditions exists in a download cache memory according to a video playing request of a browser;

if yes, then step 102 and step 106 are performed;

and if no, then step 105 is performed.

The first download node may be an application in a terminal of a browser application and invoked by the browser.

Wherein, the video address of the browser is preset as the address of a download cache memory. Therefore, the browser may request to acquire data from the download cache memory corresponding to the video address according to the video address.

The browser, after receiving the video playing request, invokes the first download node to query whether the slicing data of the network video requested for playing and satisfying playing conditions exists in the pre-established download cache memory according to the video playing request.

The playing conditions refer to conditions that the slicing data in the download cache memory may satisfy the playing demands of the browser. For example, the playing conditions may be that the play time of the slicing data of the network video in the download cache memory is longer than a preset time, or the data volume of the slicing data of the network video in the download cache memory is greater than a preset number, so as to ensure that the browser may quickly start playing the network video and ensure the user experience.

The preset time or the preset number may be determined according to the time that the first download node acquires the slicing data from the P2P server, so as to ensure that the network video may be continuously played.

Wherein, the slicing data is acquired by slicing the video data of the network video to facilitate data sharing and downloading.

The video data of the network video may be TS data in a TS (transport stream) encapsulation format, wherein the network video server provides the TS data of the network video and an M3U8 description file of the TS data.

In step 102: a second download node having other slicing data of the network video excluding the slicing data in the download cache memory is queried from the P2P server.

In step 103: other slicing data excluding the slicing data in the download cache memory is downloaded from the second download node, and stored in the download cache memory.

In step 104: the P2P server is notified that the slicing data in the current download cache memory for downloading could be provided.

In step 105: the video data of the network video is downloaded from a network video server, the video data is sliced into a plurality of slicing data, and stored the slicing data in the download cache memory, and then step 104 is performed.

Wherein, when the video data is TS data, downloading the video data of the network video from the network video server may be: acquiring the m3u8 description file from the network video server; and the TS data is downloaded according to the description information of the TS data in the m3u8 description file.

In step 106: the slicing data in the download cache memory is merged and encapsulated into video data and provided to the browser so that the browser acquires and plays the video data.

If no slicing data satisfying the playing condition exists in the download cache memory, then it indicates that the slicing data in the download cache memory cannot satisfy the demands on starting playing. In order to ensure that the playing of the network video can be quickly, the video data of the network video can be downloaded from the network video server, sliced into slicing data and stored in the download cache memory until the slicing data satisfying the playing conditions exists in the download cache memory; meanwhile, the slicing data in the download cache memory is notified to the P2P server to implement data sharing to facilitate other download nodes to download.

If the slicing data satisfying the playing condition exists in the download cache memory, i.e., the slicing data satisfying the playing condition in the download cache memory can satisfy the demands on starting playing, then it is not needed to download the video data from the network video server. Instead, a second download node having other slicing data of the network video excluding the slicing data in the download cache memory may be queried from the P2P server, so that the other slicing data of the network video may be downloaded from the second download node directly, and stored in the download cache memory.

In order to enable the browser to play the data, the slicing data in the download cache memory needs to be merged and encapsulated by the first download node. To be specific, each slicing data includes time information; therefore, the slicing data may be merged and encapsulated into video data and provided to the browser according to the time information of the slicing data and according to the order of sequence of the play time, then the browser may acquire the video data for playing.

In the embodiment, the downloading and sharing of the video data of the network video are implemented through a P2P technology, so as not need to download the video data of the network video completely from the network video server, so that the bandwidth resources occupied by downloading the videos are saved.

Wherein, the second download node may be any download node having any slicing data of the other slicing data.

Implementing the downloading and sharing of the video data through the P2P technology may specifically be as follows:

it is provided that the first download node queries download nodes having slicing data f1, f2, f3, . . . , from the P2P server; if the slicing data fl exists in one download node, then the slicing data f1 may be downloaded from the download node, and the P2P server is notified that the first download node may also improve the slicing data f1 for downloading; if the slicing data f2 exists in another download node, then the slicing data f2 may be downloaded from the download node in the meanwhile, and the P2P server is notified that the first download node may also provide the slicing data f1 for downloading.

If the slicing data f1 exists in a plurality of download nodes, then any download node may be selected or one download node with the optimal route may be selected for downloading.

To facilitate distinguishing, any download node having any slicing data in the other slicing data is described as a second download node in the embodiment.

If the play format of the slicing data in the download cache memory is different from the play format supported by the browser, then the first download node may encapsulate the slicing data into the play format supported by the browser while merging the slicing data.

That is, the merging and encapsulating the slicing data in the download cache memory into the video data and providing the video data to the browser so that the browser acquires and plays the video data includes:

merging and encapsulating the slicing data in the download cache memory into the video data in the play format supported by the browser and then providing the slicing data to the browser according to the play format supported by the browser so that the browser acquires and plays the video data.

For example, the play format of the video data sliced into slicing data is TS, and the play format supported by the browser is fmp4, then the slicing data needs to be merged and encapsulated into the video data in an fmp4 format, so that the data may be played by the browser.

The network video server in the embodiment of the present invention may refer to a source video server of the video data of the network video provided by a video service provider, while in a network architecture, the video data provided by the source video server needs to pass through a relay server and a CDN (content delivery network) server, and then is transmitted to the terminal; therefore, the network video server may refer to a CDN server. The CDN server of the video service provider may be configured in different places, and the video data may be delivered to proximate terminals everywhere through the CDN server, so that the terminal may acquire contents needed approximately, so that the speed of response of the video may be improved.

In the embodiment of the present invention, data may be continuously stored in the download cache memory to play the data via the browser; therefore, as a probable implementation manner, the download cache memory may be a MediaSource (video source) object pre-established by the first download node. Through the MediaSource object, a dataflow may be dynamically established and used for the <audio> and <video> of the browser, and the data may be transmitted to the browser to continuously add and play the data.

As another embodiment, in order to facilitate sharing and downloading the data, while downloading the video data from the network video server, slicing the video data into a plurality of slicing data and storing the slicing data in the download cache memory, the method further includes the following steps:

a first data list of the plurality of slicing data is established, the first data list including the description information of each slicing data;

wherein notifying the P2P server that the slicing data in the current download cache memory may be provided for downloading may specifically include:

notifying the P2P server that slicing data in the data list of the first download node for downloading could be provided;

wherein description information of each slicing data may include the time, size, download resource and shared times of the slicing data, etc.

The querying the second download node having other slicing data excluding the slicing data from the P2P server, downloading the other slicing data excluding the slicing data from the second download node, storing the other slicing data in the download cache memory, and notifying the P2P server that the slicing data in the current download cache memory may be provided for downloading could specifically include:

querying the data lists of different download nodes from the P2P server, and acquiring the second download node having other slicing data excluding the slicing data in the download cache memory;

downloading other slicing data excluding the slicing data in the download cache memory from the second download node according to the description information in a second data list of the second download node, and storing the slicing data in the download cache memory;

updating a first data list of the first download node according to the description information of the slicing data downloaded by the first download node; and

notifying the P2P server that the slicing data in the data list of the first download node for downloading could be provided.

Wherein, the updating the data list of the first download node according to the description information of the slicing data downloaded by the first download node may specifically be: adding the description information of the slicing data downloaded by the first download node into the data list.

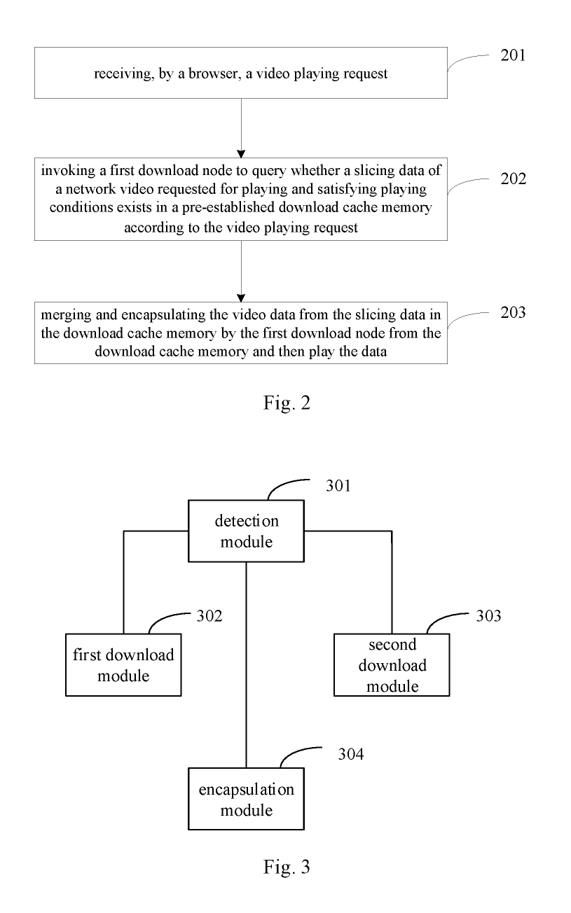

FIG. 2 is a flow chart of another embodiment of the method for playing network videos provided by the present invention. The method may be specifically applied in a browser, and the method may include the following several steps.

In step 201: a video playing request is received by a browser.

The video playing request may be triggered by a user.

The video playing request may carry related information of the network video requested for playing, for instance, name or identity, or the like, to facilitate downloading the network video.

In step 202: a first download node is invoked to query whether a slicing data of a network video requested for playing and satisfying playing conditions exists in a pre-established download cache memory according to the video playing request; if yes, a second download node having other slicing data excluding the slicing data in the download cache memory is queried from the P2P server, the other slicing data excluding the slicing data in the download cache memory is downloaded from the second download node, the other slicing data is stored in the download cache memory, and the P2P server is notified that the slicing data in the current download cache memory; and if no, the video data of the network video is downloaded from a network video server, the video data is sliced into a plurality of slicing data, and stored in the download cache memory.

Wherein, the video address of the browser is preset as the address of the download cache memory.

In step 203: the video data merged and encapsulated from the slicing data in the download cache memory by the first download node is acquired and played from the download cache memory.

In the embodiment, the browser after receiving the video playing request invokes the first download node to download the video data of the network video, and the first download node may download the video data of the network video from the network video server, and slice the video data into a plurality of slicing data, notify the P2P server, and declare the slicing data possessed thereof, and may also download the slicing data of the video data of the network video from other download node via a P2P technology, so that the video data may be downloaded through the P2P technology when the slicing data in the download cache memory satisfies the playing conditions; therefore, the bandwidth occupied by downloading the video from the network video server may be reduced, and the bandwidth resources may be saved.

FIG. 3 is a structure diagram of one embodiment of a device for playing network videos provided by the present invention, wherein the device may include:

A detection module 301 is configured to query whether a slicing data of a network video requested for playing and satisfying playing conditions exists in a pre-established download cache memory according to a video playing request of a browser;

wherein, the video address of the browser is preset as the address of the download cache memory. Therefore, the browser may request to acquire data from a download cache memory corresponding to the video address according to the video address.

The playing conditions for example, may be that the play time of the slicing data of the network video in the download cache memory is longer than a preset time, or the data volume of the slicing data of the network video in the download cache memory is greater than a preset number.

Therefore, as another embodiment, the detection module may be specifically configured to query whether the slicing data of a first number of the network video requested for playing having a play time longer than a preset time exists in the download cache memory according to the video playing request of the browser.

Wherein, the slicing data is acquired by slicing the video data of the network video to facilitate data sharing and downloading.

A first download module 302 is configured to, when the detection result of the detection module is no, download the video data of the network video from the network video server, slice the video data into a plurality of slicing data, store the slicing data in the download cache memory, and notify the P2P server the slicing data in the current download cache memory.

A second download module 303 configured to, if the detection result of the detection module is yes, query a second download node having other slicing data excluding the slicing data in the download cache memory from the P2P server, download the other slicing data excluding the slicing data in the download cache memory from the second download node, store the other slicing data in the download cache memory, and notify the P2P server the slicing data in the current download cache memory.

A encapsulation module 304 is configured to merge and encapsulate the slicing data in the download cache memory into video data and providing the video data to the browser so that the browser acquires and plays the video data.

If no slicing data satisfying the playing condition exists in the download cache memory, then it indicates that the slicing data in the download cache memory cannot satisfy the demands on starting playing. In order to ensure that the playing of the network video can be quickly, the video data of the network video can be downloaded from the network video server, sliced into slicing data and stored in the download cache memory until the slicing data satisfying the playing conditions exists in the download cache memory; meanwhile, the slicing data in the download cache memory is notified to the P2P server to implement data sharing to facilitate other download nodes to download.

If the slicing data satisfying the playing condition exists in the download cache memory, i.e., the slicing data satisfying the playing condition in the download cache memory can satisfy the demands on starting playing, then it is not needed to download the video data from the network video server. Instead, a second download node having other slicing data of the network video excluding the slicing data in the download cache memory may be queried from the P2P server, so that the other slicing data of the network video may be downloaded from the second download node directly, and stored in the download cache memory.

In the embodiment, the downloading and sharing of the video data of the network video are implemented through a P2P technology, so as not need to download the video data of the network video completely from the network video server, so that the bandwidth resources occupied by downloading the videos are saved.

Wherein, the second download node may be any download node having any slicing data of the other slicing data.

Wherein, each slicing data includes time information, and the encapsulation module merges and encapsulates the slicing data in the download cache memory. To be specific, the slicing data may be merged and encapsulated into video data and provided to the browser according to the time information of the slicing data and according to the order of sequence of the play time, then the browser may acquire the video data for playing.

If the play format of the slicing data in the download cache memory is different from the play format supported by the browser, as another embodiment herein, the encapsulation module may be specifically configured to:

merge and encapsulate the slicing data in the download cache memory into the video data in a play format supported by the browser and then provide the slicing data to the browser according to the play format supported by the browser so that the browser acquires and plays the video data.

For example, the play format of the video data sliced into slicing data is TS, and the play format supported by the browser is fmp4, then the slicing data needs to be merged and encapsulated into the video data in an fmp4 format, so that the data may be played by the browser.

In the embodiment of the present invention, data may be continuously stored in the download cache memory to play the data via the browser; therefore, as a probable implementation manner, the download cache memory may be a pre-established MediaSource (video source) object. Through the MediaSource object, a dataflow may be dynamically established and used for the <audio> and <video> options of the browser, and the data may be transmitted to the browser to continuously add and play the data. Therefore, the device may also include:

a pre-establishment module configured to establish a download cache memory, wherein the download cache memory may specifically be a MediaSource object.

As another embodiment, in order to facilitate data sharing and downloading, the device may also include:

a list establishing module configured to, after the first download module downloads the video data from the network video server, and slices the video data into a plurality of slicing data, establish a first data list of the plurality of slicing data, the first data list including the description information of each slicing data;

then the notifying, by the first download module, the P2P server that the slicing data in the current download cache memory for downloading could be provided, may specifically include:

the slicing data in the data list for downloading could be provided; and

the second download module may be specifically configured to: query the data lists of different download nodes from the P2P server, and acquire the second download node having other slicing data excluding the slicing data in the download cache memory; download other slicing data excluding the slicing data in the download cache memory from the second download node according to the description information in a second data list of the second download node, and store the other slicing data in the download cache memory; update a first data list according to the description information of the slicing data downloaded by the first download node; and notifying the P2P server that the slicing data in the first data list for downloading could be provided.

Wherein, the updating the data list of the first download node according to the description information of the slicing data downloaded by the first download node may specifically be: adding the description information of the slicing data downloaded by the first download node into the data list.

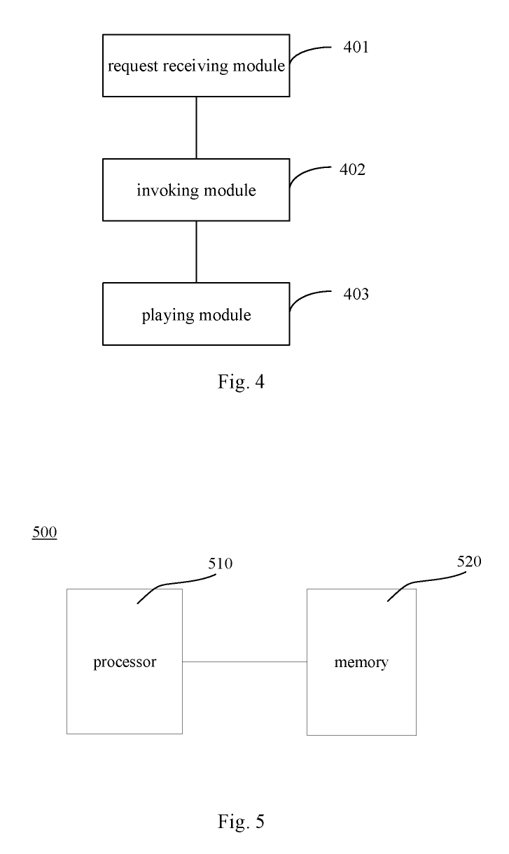

FIG. 4 is a structure diagram of another embodiment of the video playing device provided by the present invention. The device according to the embodiment may be specifically applied to a browser, and the device may include:

a request receiving module 401 is configured to receive a video playing request.

The video playing request may be triggered by a user.

The video playing request may carry related information of the network video requested for playing, for instance, name or identity, or the like, to facilitate downloading the network video.

A invoking module 402 is configured to invoke a first download node to query whether a slicing data of a network video requested for playing and satisfying playing conditions exists in a pre-established download cache memory according to the video playing request; if yes, query a second download node having other slicing data excluding the slicing data in the download cache memory from the P2P server, download the other slicing data excluding the slicing data in the download cache memory from the second download node, store the other slicing data in the download cache memory, and notify the P2P server that the slicing data in the current download cache memory; and if no, download the video data of the network video from a network video server, slice the video data into a plurality of slicing data, and store the slicing data in the download cache memory.

The playing module 403 is configured to acquire the video data merged and encapsulated from the slicing data in the download cache memory by the first download node from the download cache memory and playing the data.

In the embodiment, the device for playing network videos after receiving the video playing request may invoke the first download node to download the video data of the network video, and the first download node may download the video data of the network video from the network video server, and slice the video data into a plurality of slicing data, notify the P2P server, and declare the slicing data possessed thereof, and may also download the slicing data of the video data of the network video from other download node via a P2P technology, so that the video data may be downloaded through the P2P technology when the slicing data in the download cache memory satisfies the playing conditions; therefore, the bandwidth occupied by downloading the video from the network video server may be reduced, and the bandwidth resources may be saved.

The present invention also provides a system for playing network videos, which may include a browser, a download cache memory and a download node, wherein the browser is configured with the device for playing network videos as shown in FIG. 4, and the download node is configured with the device for playing network videos as shown in FIG. 3.

The download cache memory is pre-established by the download node, and may be a MediaSource object.

The bandwidth occupied by downloading the network video may be reduced through the system for playing network videos according to the embodiment of the present invention, so that the bandwidth resources are saved.

FIG. 5 is a structural diagram of a device for playing network videos according to another embodiment. The device 500 includes:

a processor 510; and

a memory 520 for storing instructions executable by the processor 510;

wherein the processor 510 is configured to:

query whether a slicing data of a network video requested for playing and satisfying playing conditions exists in a pre-established download cache memory according to a video playing request of a browser, wherein the video address of the browser is preset as the address of the download cache memory;

when the detection result of the detection module is no, download the video data of the network video from the network video server, slice the video data into a plurality of slicing data, store the slicing data in the download cache memory, and notify aP2P server that the slicing data in the current download cache memory for downloading could be provided;

if the detection result of the detection module is yes, query a second download node having other slicing data excluding the slicing data in the download cache memory from the P2P server, download the other slicing data excluding the slicing data in the download cache memory from the second download node, store the other slicing data in the download cache memory, and notify the P2P server that the slicing data in the current download cache memory for downloading could be provided; and

merge and encapsulate the slicing data in the download cache memory into video data and providing the video data to the browser so that the browser acquires and plays the video data.

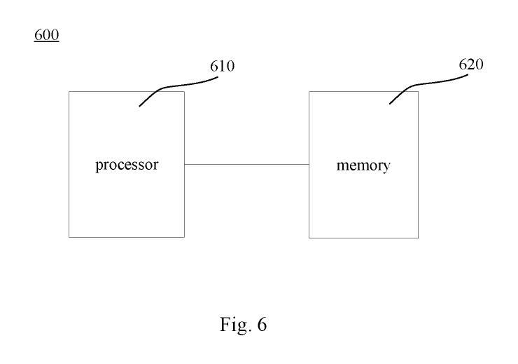

FIG. 6 is a structural diagram of an electronic device according to another embodiment. The device 600 includes:

a processor 610; and

a memory 620 for storing instructions executable by the processor 610;

wherein the processor 610 is configured to:

receive a video playing request;

invoke a first download node to query whether a slicing data of a network video requested for playing and satisfying playing conditions exists in a pre-established download cache memory according to the video playing request; if no, download the video data of the network video from a network video server, slice the video data into a plurality of slicing data, store the slicing data in the download cache memory, and notify a P2P server that the slicing data in the current download cache memory for downloading could be provided; and if yes, query a second download node having other slicing data excluding the slicing data in the download cache memory from the P2P server, download the other slicing data excluding the slicing data in the download cache memory from the second download node, store the other slicing data in the download cache memory, and notify the P2P server that the slicing data in the current download cache memory for downloading could be provided; and

acquire the video data merged and encapsulated from the slicing data in the download cache memory by the first download node from the download cache memory and playing the data

The device embodiments described above are only exemplary, wherein the units illustrated as separation parts may either be or not physically separated, and the parts displayed by units may either be or not physical units, i.e., the parts may either be located in the same plate, or be distributed on a plurality of network units. A part or all of the modules may be selected according to an actual requirement to achieve the objectives of the solutions in the embodiments. Those having ordinary skills in the art may understand and implement without going through creative work.

Through the above description of the implementation manners, those skilled in the art may clearly understand that each implementation manner may be achieved in a manner of combining software and a necessary common hardware platform, and certainly may also be achieved by hardware. Based on such understanding, the foregoing technical solutions essentially, or the part contributing to the prior art may be implemented in the form of a software product. The computer software product may be stored in a storage medium such as a ROM/RAM, a diskette, an optical disk or the like, and includes several instructions for instructing a computer device (which may be a personal computer, a server, or a network device so on) to execute the method according to each embodiment or some parts of the embodiments.

It should be finally noted that the above embodiments are only configured to explain the technical solutions of the present invention, but are not intended to limit the present invention. Although the present invention has been illustrated in detail according to the foregoing embodiments, those having ordinary skills in the art should understand that modifications can still be made to the technical solutions recited in various embodiments described above, or equivalent substitutions can still be made to a part of technical features thereof, and these modifications or substitutions will not make the essence of the corresponding technical solutions depart from the spirit and scope of the claims.

1. A method for playing network videos, comprising:
querying, by a first download node, whether a slicing data of a network video requested for playing and satisfying playing conditions exists in a pre-established download cache memory according to a video playing request of a browser, wherein the video address of the browser is preset as the address of the download cache memory;
if no, downloading the video data of the network video from a network video server, slicing the video data into a plurality of slicing data, storing the slicing data in the download cache memory, and notifying a P2P server that the slicing data in the current download cache memory for downloading could be provided; and
if yes, querying a second download node having other slicing data excluding the slicing data in the download cache memory from the P2P server, downloading the other slicing data excluding the slicing data in the download cache memory from the second download node, storing the other slicing data in the download cache memory, and notifying the P2P server that the slicing data in the current download cache memory for downloading may be provided; and
merging and encapsulating the slicing data in the download cache memory into video data and providing the video data to the browser so that the browser acquires and plays the video data.

2. The method according to claim 1, wherein the merging and encapsulating the slicing data in the download cache memory into video data and providing the video data to the browser so that the browser acquires and plays the video data comprises:
merging and encapsulating the slicing data in the download cache memory into the video data in a play format supported by the browser and then providing the slicing data to the browser according to the play format supported by the browser so that the browser acquires and plays the video data.

3. The method according to claim 1, wherein the querying whether the slicing data of the network video requested for playing satisfying the playing conditions exists in the download cache memory comprises:
querying whether the slicing data of a first number of the network video requested for playing having a play time longer than a preset time exists in the download cache memory.

4. The method according to claim 1, wherein the download cache memory is a video source MediaSource object pre-established by the first download node.

5. The method according to claim 1, wherein after the downloading the video data from the network video server, and slicing the video data into a plurality of slicing data, the method further comprises:
establishing a first data list of the plurality of slicing data, the first data list comprising the description information of each slicing data;
the notifying the P2P server that the slicing data in the current download cache memory for downloading could be provided comprises:
notifying the P2P server that the slicing data in the first data list for downloading could be provided; and
the querying the second download node having other slicing data excluding the slicing data from the P2P server, downloading the other slicing data excluding the slicing data from the second download node, storing the other slicing data in the download cache memory, and notifying the P2P server that the slicing data in the current download cache memory for downloading could be provided comprises:
querying the data lists of different download nodes from the P2P server, and acquiring the second download node having other slicing data excluding the slicing data in the download cache memory;
downloading other slicing data excluding the slicing data in the download cache memory from the second download node according to the description information in a second data list of the second download node, and storing the other slicing data in the download cache memory; and
updating a first data list according to the description information of the slicing data downloaded by the first download node; and
notifying the P2P server that the slicing data in the first data list for downloading could be provided.

6. A method for playing network videos, comprising:
receiving, by a browser, a video playing request;
invoking a first download node to query whether a slicing data of a network video requested for playing and satisfying playing conditions exists in a pre-established download cache memory according to the video playing request; if no, downloading the video data of the network video from a network video server, slicing the video data into a plurality of slicing data, storing the slicing data in the download cache memory, and notifying a P2P server that the slicing data in the current download cache memory for downloading could be provided; and if yes, querying a second download node having other slicing data excluding the slicing data in the download cache memory from the P2P server, downloading the other slicing data excluding the slicing data in the download cache memory from the second download node, storing the other slicing data in the download cache memory, and notifying the P2P server that the slicing data in the current download cache memory for downloading could be provided; and
acquiring the video data merged and encapsulated from the slicing data in the download cache memory by the first download node from the download cache memory and playing the data.

7. A device for playing network videos, comprising:
a processor; and
a memory for storing instructions executable by the processor;
wherein the processor is configured to:
query whether a slicing data of a network video requested for playing and satisfying playing conditions exists in a pre-established download cache memory according to a video playing request of a browser, wherein the video address of the browser is preset as the address of the download cache memory;
when the detection result of the detection module is no, download the video data of the network video from the network video server, slice the video data into a plurality of slicing data, store the slicing data in the download cache memory, and notify aP2P server that the slicing data in the current download cache memory for downloading could be provided;
if the detection result of the detection module is yes, query a second download node having other slicing data excluding the slicing data in the download cache memory from the P2P server, download the other slicing data excluding the slicing data in the download cache memory from the second download node, store the other slicing data in the download cache memory, and notify the P2P server that the slicing data in the current download cache memory for downloading could be provided; and
merge and encapsulate the slicing data in the download cache memory into video data and providing the video data to the browser so that the browser acquires and plays the video data.

8. The device according to claim 7, wherein the processor is further configured to:
merge and encapsulate the slicing data in the download cache memory into the video data in a play format supported by the browser and then provide the slicing data to the browser according to the play format supported by the browser so that the browser acquires and plays the video data.

9. The device according to claim 7, wherein the processor is further configured to:
query whether the slicing data of a first number of the network video requested for playing having a play time longer than a preset time exists in the download cache memory according to the video playing request of the browser.

10. The device according to claim 7, wherein the processor is further configured to:
after the first download module downloads the video data from the network video server, and slices the video data into a plurality of slicing data, establish a first data list of the plurality of slicing data, the first data list comprising the description information of each slicing data;
the notifying, by the first download module, the P2P server that the slicing data in the current download cache memory for downloading could be provided, specifically comprises:
notifying the P2P server that the slicing data in the data list for downloading could be provided; and
the second display unit is specifically configured to: query the data lists of different download nodes from the P2P server, and acquire the second download node having other slicing data excluding the slicing data in the download cache memory; download other slicing data excluding the slicing data in the download cache memory from the second download node according to the description information in a second data list of the second download node, and store the other slicing data in the download cache memory; update a first data list according to the description information of the slicing data downloaded by the first download node; and notifying the P2P server that the slicing data in the first data list for downloading could be provided.

11. A device for playing network videos, comprising:
a processor; and
a memory for storing instructions executable by the processor;
wherein the processor is configured to:
receive a video playing request;
invoke a first download node to query whether a slicing data of a network video requested for playing and satisfying playing conditions exists in a pre-established download cache memory according to the video playing request; if no, download the video data of the network video from a network video server, slice the video data into a plurality of slicing data, store the slicing data in the download cache memory, and notify a P2P server that the slicing data in the current download cache memory for downloading could be provided; and if yes, query a second download node having other slicing data excluding the slicing data in the download cache memory from the P2P server, download the other slicing data excluding the slicing data in the download cache memory from the second download node, store the other slicing data in the download cache memory, and notify the P2P server that the slicing data in the current download cache memory for downloading could be provided; and
acquire the video data merged and encapsulated from the slicing data in the download cache memory by the first download node from the download cache memory and playing the data.

12. A system for playing network videos, characterized in that, comprising a browser, a download node and a download cache memory, wherein:
the download cache memory is pre-established by the download node;
the download node is configured with the device for playing network videos according to any one of claims 7 to 10; and
the browser is configured with the device for playing network videos according to claim 11.
